(19) United States
(12) Patent Application Publication
(10) Pub. No.: US 2014/0365877 A1
(43) Pub. Date: Dec. 11, 2014

(54) File History Tagging

(71) Applicant: Apple Inc., Cupertino, CA (US)

(72) Inventors: Eric Jacobson, San Jose, CA (US); Heather L. Winkle, Richmond, VA (US); Nikita Pisliakov, Ottawa (CA); Clay Maeckel, San Jose, CA (US); Toufic Milan, Ottawa (CA)

(21) Appl. No.: 13/910,957

(22) Filed: Jun. 5, 2013

(51) Int. Cl. G06F 17/24

(52) U.S. Cl. CPC G06F 17/24
USPC 715/255

(57) ABSTRACT

A history of uploading an electronic document to one or more destinations is stored as a file tag. The file tag can be a portion of metadata associated with the document. Each time the document is copied to a new location, e.g., uploaded to a database server or a webserver, the location is stored in the tag. When the document is copied locally, the operating system can copy the tag with the document. When the tagged document is edited, a prompt can be displayed. The prompt can provide an option for editing the document locally and an option for editing the uploaded copy.

### TECHNICAL FIELD

This disclosure relates generally to file management.

### BACKGROUND

An electronic document can be copied and edited. Changes made in the original document after a copy of the document was created generally are not reflected in the copy. When multiple copies of the document are created, and each copy edited independently, tracking which copy has changed in what way can be complex. Conventionally, a revision control system (also known as a version control system or source control system) can be utilized to manage changes to a document when the multiple versions of the document, or its copies, are edited. A revision control system can store multiple versions of a document, allow the document to be checked out for editing, and merge changes when the document is checked back in after editing. The information on document changes is stored in the revision control system.

### SUMMARY

File history tagging techniques are described. A history of uploading an electronic document to one or more destinations is stored as a file tag. The file tag can be a portion of metadata associated with the document. Each time the document is copied to a new location, e.g., uploaded to a database server or a webserver, the location is stored in the tag. When the document is copied locally, the operating system can copy the tag with the document. When the tagged document is edited, a prompt can be displayed. The prompt can provide an option for editing the document locally and an option for editing the uploaded copy.

The features described in this specification can be implemented to achieve the following advantages. A file can “remember” to which system the file has been copied. For example, the file can include information that the file has been uploaded to a cloud storage device, a database server, or a web site. Unlike a conventional revision control mechanism, the information can relate to where the file has been copied to, in addition to the information on when the file was edited or by whom. The features described in this specification can allow a user to track where the user has uploaded the file. This information can be helpful when the user forgets which file the user has uploaded, and to what destination.

The features described in this specification can allow information on upload history of a file to become a part of the file, and independent of a revision control system. Accordingly, if the file is copied, the information is copied. Regardless of whether a user tries to edit the original file or a copy of the file, the user can be reminded that the file has already been uploaded, and provided an opportunity to modify the uploaded file.

The features described in this specification can allow history of a file be tracked independent of a conventional revision control system. The history is stored in the tag that goes with the file, rather than with a revision control system. Accordingly, no additional revision control mechanism is needed. For example, a user does not need to check in, check out, or merge a file.

The details of one or more implementations of file history tagging are set forth in the accompanying drawings and the description below. Other features, aspects, and advantages of file history tagging will become apparent from the description, the drawings, and the claims.

### BRIEF DESCRIPTION OF THE DRAWINGS

FIG. 1 is a diagram illustrating a conventional revision control system.

FIG. 2 is a diagram illustrating an exemplary implementation of file history tagging.

FIG. 3 is a block diagram illustrating components of an exemplary file history tagging system.

FIG. 4 is a diagram illustrating an exemplary structure of metadata storing a file history.

FIGS. 5A and 5B illustrate exemplary user interfaces for file history tagging.

FIG. 6 is a flowchart of an exemplary procedure of file history tagging.

FIG. 7 is a block diagram of an exemplary system architecture for implementing the features and operations of file history tagging.

Like reference symbols in the various drawings indicate like elements.

### DETAILED DESCRIPTION

Exemplary File History Tagging

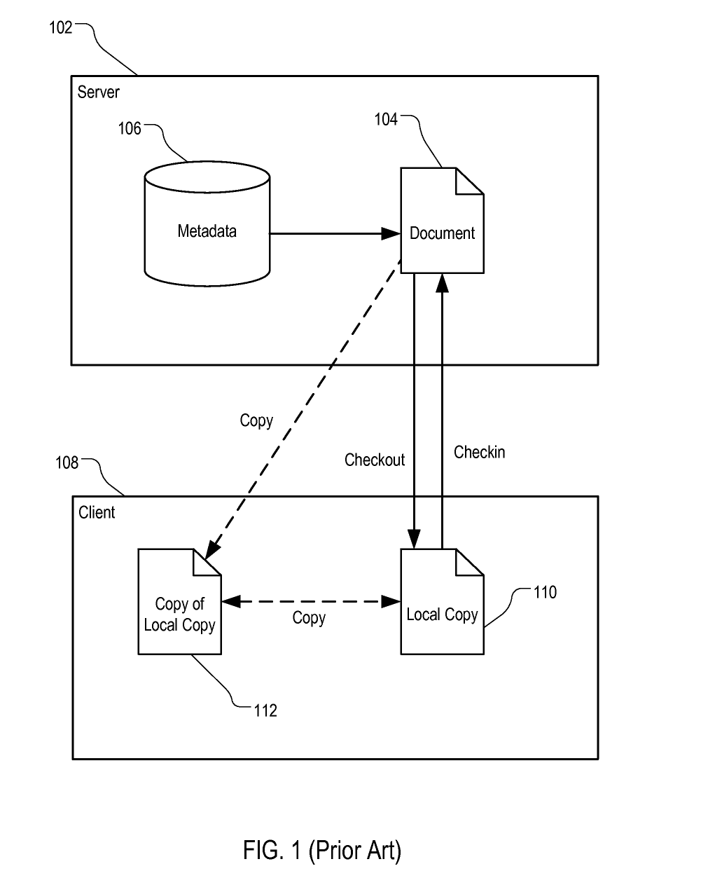

FIG. 1 is a diagram illustrating a conventional revision control system. The system can include server 102. Server 102 can manage revisions of document 104. Document 104 can be an electronic document stored on a computer-readable medium. Server 102 can store metadata 106. Metadata 106 can include revision information of document 104. The information can include, for example, the last modified date, whether document 104 is checked out by a particular user and prevented from being edited by other users, and a current version number of document 104. On server 102, metadata 106 are typically stored separately from document 104.

The system can include client 108. A user can check out document 104 using client 108. Checking out document 104 can include generating a copy of document 104, and store the copy as local copy 110 on client 108. After document 104 has been checked out, server 102 can designate document 104 as read-only, and prevent document 104 from being checked out by another client. In some implementations, server 102 can allow other clients to check out document 104, but record the checkouts such that when document 104 is checked in, server 102 can merge changes. Server 102 can store the status of document 104 in metadata 106. The status can include, for example, which user has edited document 104, and when the editing occurred.

Once document 104 is checked out as local copy 110, client 108 can perform various actions on local copy 110. For example, client 108 can modify local copy 110, or create document 112. Document 112 can be a copy of local copy 110, or a copy of document 104 that is create outside of server 102′s knowledge (e.g., a copy of document 104 created without using a checkout procedure). In both cases, the revision control system may not have information of document 112. Due to the lack of information, unless document 112 is added to the revision control system, the revision control system may not update document 104 when document 112 is revised. Likewise, the revision control system may not request client 108 to merge changes happened to document 104 into document 112 if document 104 is changed by another client.

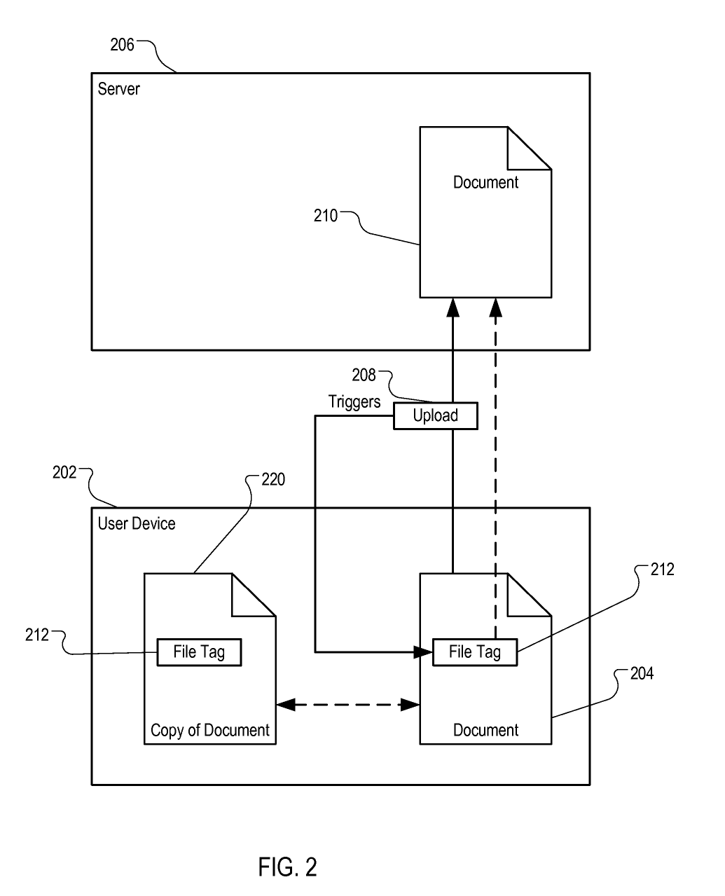

FIG. 2 is a diagram illustrating an exemplary implementation of file history tagging. User device 202 can store an electronic document, e.g., document 204. User device 202 can receive a request to upload document 204 to server 206. Server 206 can be a server computer located remotely from user device 202 and connected to user device 202 through a communications network. Server 206 can include a database server or a cloud storage device. User device 202 can perform upload action 208. Upload action 208 can include creating remote copy 210 of document 204 on server 206.

Upload action 208 can trigger a tagging action of creating file tag 212. The tagging action can be performed by user device 202. File tag 212 can include a string specifying server 206, to which document 204 was uploaded. The string can include a name of a database server or a name of the cloud. File tag 212 can include a string specifying a server destination folder or cloud tenant (e.g., a work group). File tag 212 can include a file name of document 210 as stored on server 206.

User device 202 can inject file tag 212 into document 204. Injecting file tag 212 into document 204 can include storing file tag 212 as a value of a key in metadata of document 204. The metadata of document 204 can be a part of document 204. When a user device generates a copy of document 204, e.g., by creating document 220, file tag 212 is copied along with other content of document 204, and stored in document 220.

The metadata can be accessed by an application program (e.g., a file editing program) that is configured to open document 204. When user device receives a request to open document 204 using the application program (e.g., for editing) the application program can read file tag 212 and determine that document 204 has remote copy 210. The application program can then provide a user interface item for choosing which of document 204 or remote copy 210 to open. Similarly, when user device receives a request to open document 220, the application program can then provide a user interface item for choosing which of document 204 or remote copy 210 to open. If remote copy 210 is chosen, the application program can cause remote copy 210, rather than document 204 or document 220, to be opened for editing.

### Exemplary System Components

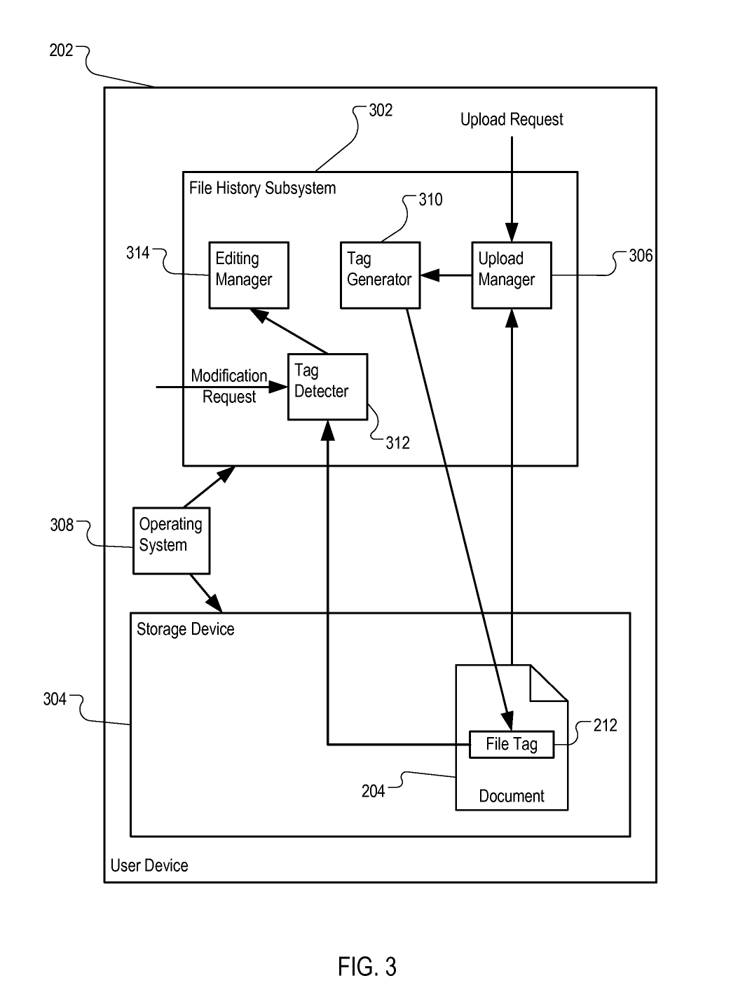

FIG. 3 is a block diagram illustrating components of an exemplary file history tagging system. For convenience, the file history tagging system will be described in reference to user device 202.

User device 202 can include file history subsystem 302 and storage device 304 (e.g., a local disk). Storage device 304 can store document 204. File history subsystem 302 can be a component of user device 202 that includes hardware and software for creating and injecting file tags into document 204. File history subsystem 302 can include upload manager 306. Upload manager 306 is a component of file history subsystem 302 configured to receive, from operating system 308, a request to upload document 204 to a remote server. The request can include an identifier of the server and information on where in the server a copy of document 204 is to be placed. Upload manager 306 can provide the identifier and information in the request, a local file name of document 204, and optionally, a remote file name of document 204, to tag generator 310.

Tag generator 310 is a component of file history subsystem 302 configured to construct file tag 212 for document 204 and inject file tag 212 into document 204 as a value of a reserved key. Upon receiving information from upload manager 306, tag generator can construct file tag 212, and modify document 204 through operating system 308. Document 204, as modified, can include file tag 212 after being uploaded.

File history subsystem 302 can include tag detector 312. Tag detector 312 is a component of file history subsystem 302 configured to receive, from an application program executing in operating system 308, a modification request for modifying (e.g., editing) document 204. Upon receiving the modification request, tag detector 312 can examine document 204, including reading metadata in document 204 to determine if a file tag is in stored as a value of a reserved key in the metadata. The reserved key can be a key designated for system use (e.g., read-only by a user).

If tag detector 312 detects no file tag, tag detector 312 can direct the application program to open document 204. If tag detector 312 detects file tag 212 from the metadata, tag detector 312 can provide information of file tag 212 to editing manager 314. Editing manager 314 is a component of file history subsystem 302 configured to determine a location of a remote copy of document 204 and provide a user interface for selecting whether to open document 204 or the remote copy. If editing manager 314 receives a selection input for opening document 204 locally, editing manager 314 can direct the application program to open document 204. If editing manager 314 receives a selection for opening the remote copy, editing manager 314 can direct the application program to a remote server or cloud, and to open the remote copy stored on the remote server or cloud according to the location.

### Exemplary Data Structure

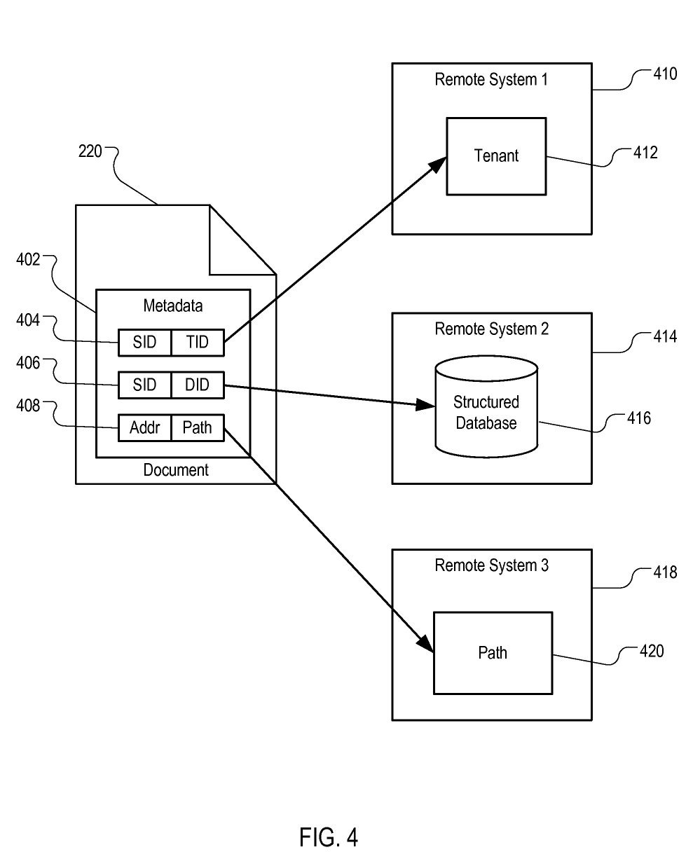

FIG. 4 is a diagram illustrating an exemplary structure of metadata storing a file history. Document 220 can be an electronic document associated with metadata 402. Metadata 402 can be a portion of document 220 that is structured, e.g., having key-value pairs where each key is a label (e.g., a string), and each value corresponding to a key. In some implementations, metadata 402 can be stored in a resource fork of document 220 configured to store structured data, for example, a name (key) and a corresponding image of an icon (value) of document 220.

Metadata 402 can include one or more file tags, e.g., file tags 404, 406, and 408. Each of file tags 404, 406, and 408 can correspond to a unique key and have a value. Each value can have a unique format corresponding to a location to which document 220 has been uploaded. For example, document 220 can be uploaded to cloud 410, which includes computer resources provided by a service over a communications network. The resources can include computing resources and storage resources. Document 220 can be uploaded to tenant 412 in cloud 410. Tenant 412 can be an exclusive virtual environment for a user (e.g., a company) in cloud 410 that is separated and isolated from other virtual environments to achieve privacy and security. When document 220 is uploaded into tenant 412 in cloud 410, metadata 402 can include file tag 404, which can include a system identifier identifying cloud 410 and tenant identifier identifying tenant 412. In addition, file tag 404 can include a name of the copy of document 220 as stored in tenant 412. File tag 404 can be a string having a form as shown below.

[cloud_provider]://[tenant_id]/[file_name]

Document 220 can be uploaded to database server 414. Database server 414 can host one or more databases. The databases can be, for example, relational, object-oriented, or ad hoc databases storing structured data. Document 220 can be uploaded to database 416 on database server 414. File tag 406 can be associated with database 416 on database server 414. File tag 406 can include a database protocol, and a database identifier identifying database 416 and database server 313 under the database protocol. File tag 406 can be a string having a form as shown below.

[database_protocol]://[database_identifier]/[file_name]

Document 220 can be uploaded to file system 418, and stored in path 420. When document 220 is uploaded to path 420 in file system 418, metadata 402 can include file tag 408, which can include an address of file system 418, and path 420. File tag 406 can be a string having a form as shown below.

[protocol]://[IP_address_or_server_name]/[path]/[file-name]

### Exemplary User Interface

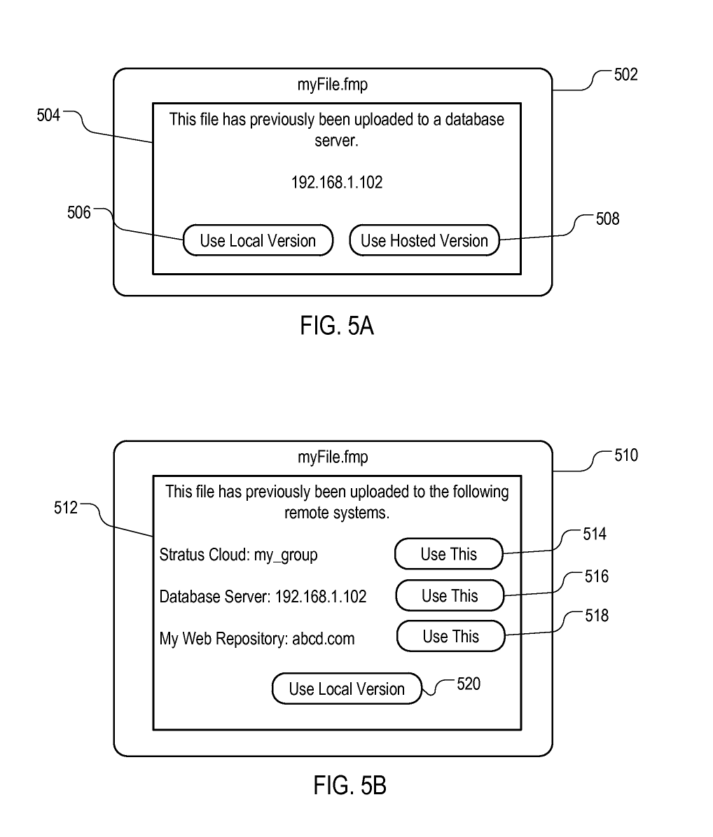

FIGS. 5A and 5B illustrate exemplary user interfaces for file history tagging. The user interfaces are shown as graphic user interfaces (GUIs) suitable for display on a display surface. In various implementations, voice user interfaces (e.g., speech synthesization output or speech recognition input) or kinetic user interfaces (e.g., vibration output or movement recognition input) can be used.

FIG. 5A illustrates user interface 502 for a document that includes one file tag specifying that a copy of the document is stored on a database server. A file tagging system can display user interface 502 in response to a request for opening the document. User interface 502 can include a file name (e.g., “myFile.fmp”) and information area 504. Information area 504 can include text specifying to which location the document was uploaded (e.g., database server at address “192.168.1.102”). Information area 504 can include user interface item 506 and user interface item 508. User interface item 506 can represent an option to open the document stored locally. User interface item 506 can represent an option to open the copy of the document stored remotely. Upon receiving an input selecting one of the options, the file tagging system can open the corresponding document for modification.

FIG. 5B illustrates user interface 510 for a document that includes multiple file tags. A document stored locally to a file tagging system can have multiple copies, each stored on a separate remote system. When the file tagging system receives a request to open the document, the file tagging system can provide user interface 510 for display. User interface 510 can include a file name and information area 512. Information area 512 can present a list of systems on each of which a copy of the document is stored. Information area 512 can present a user interface item corresponding to each system. For example, information area 512 can display a cloud (e.g., “Stratus Cloud”) and a tenant (e.g., “my_group”) in association with user interface item 514 that, if selected, will cause a copy stored at the corresponding cloud and tenant be opened. Information area 512 can display a database server (e.g., “192.168.1.102”) in association with user interface item 516 that, if selected, will cause a copy stored in the corresponding database be opened. Information area 512 can display a Web server (e.g., “abcd.com”) in association with user interface item 518 that, if selected, will cause a copy stored in the corresponding web site be opened.

In some implementations, information areas 504 and 512 can each include a user interface item for clearing file tags. If a file tagging system receives an input to clear file tags, the file tagging system can remove some or all file tags associated with a document.

### Exemplary Procedures

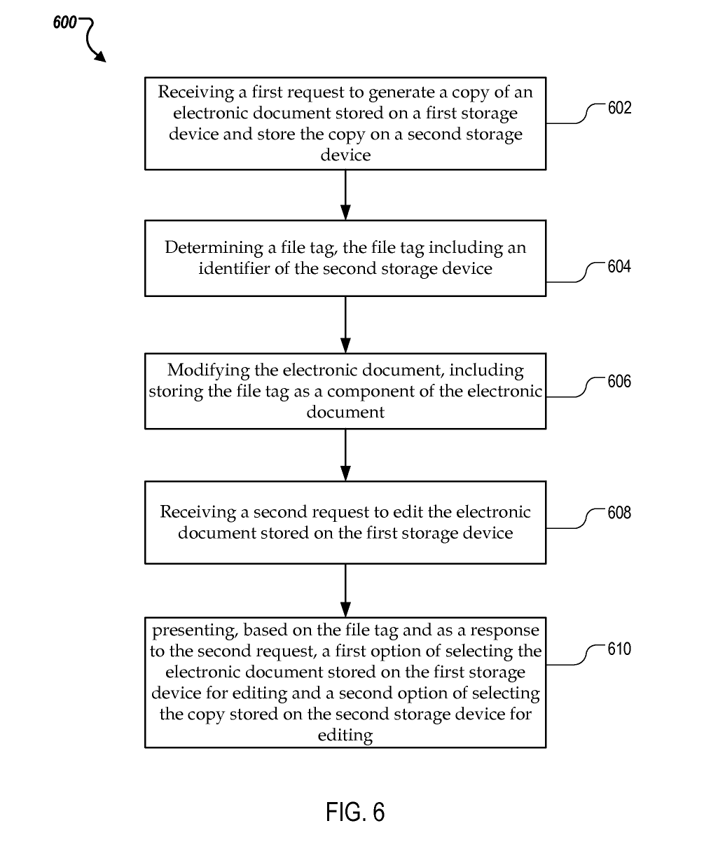

FIG. 6 is a flowchart of exemplary procedure 600 of file history tagging. Procedure 600 can be performed by a system including a computing device having one or more processors, e.g., user device 202 as described in reference to FIG. 2.

The system can receive (602), using upload manager 306, a first request to generate a copy of an electronic document (e.g., document 204) stored on a first storage device and store the copy on a second storage device. The request can include a path on the second storage device for storing the copy. The first storage device can be a storage device that is local to the system. The second storage device is a storage device located remote to the computing device and connected to the computing device through a communications network. In various implementations, the second storage device can be a cloud storage device, a network-attached storage (NAS) device, or a content repository and management system including a database server. The file tag can be stored in metadata of the electronic document as a value of a reserved key. The metadata can be associated with the electronic document, for example, as a part of the electronic document. When the electronic document is copied by an operating system (e.g., operating system 308, the metadata is copied with the electronic document.

The system can determine (604), using tag generator 310, a file tag. The file tag can include an identifier of the second storage device, a representation of the path, and a representation of an identifier of the copy. When the second storage device is a cloud storage device, the identifier of the second storage device can include a service identifier identifying a cloud storage service that manages the cloud storage device; and the path can include a tenant identifier identifying an exclusive virtual computing environment of the cloud storage service for storing the copy. When the second storage device is a NAS device, the identifier of the second storage device can include an identifier of the network and a network address of the NAS device in the network.

In some implementations, the system can determine that the electronic document is open when the first request was received. The system can close the electronic document before generating the copy, and determine a file tag after storing the copy on the second storage device.

The system can modify (606), using tag generator 310, the electronic document, including storing the file tag as a component of the electronic document. In some implementations, the electronic document can be associated with multiple file tags, each of the file tags identifying a unique remote storage device or a unique path

The system can receive (608), using tag detector 312, a second request to edit the electronic document stored on the first storage device. The second request can be received from an application program attempting to open the electronic document.

The system can present (608), based on the file tag and as a response to the second request, a first option of selecting the electronic document stored on the first storage device for editing, and a second option of selecting the copy stored on the second storage device for editing. The system can present the options through editing manager 314. When the electronic document is associated with multiple file tags, the system can present an option corresponding to each unique remote storage device or unique path.

After presenting the options, the system can open the electronic document for editing in response to an input selecting a first option. In addition, when the input selects the first option (opening the electronic document locally), the system can present a user interface item for receiving an input for removing the file tag from the electronic document. Alternatively, in response to an input selecting a second option, the system can open the copy for editing.

### Exemplary System Architecture

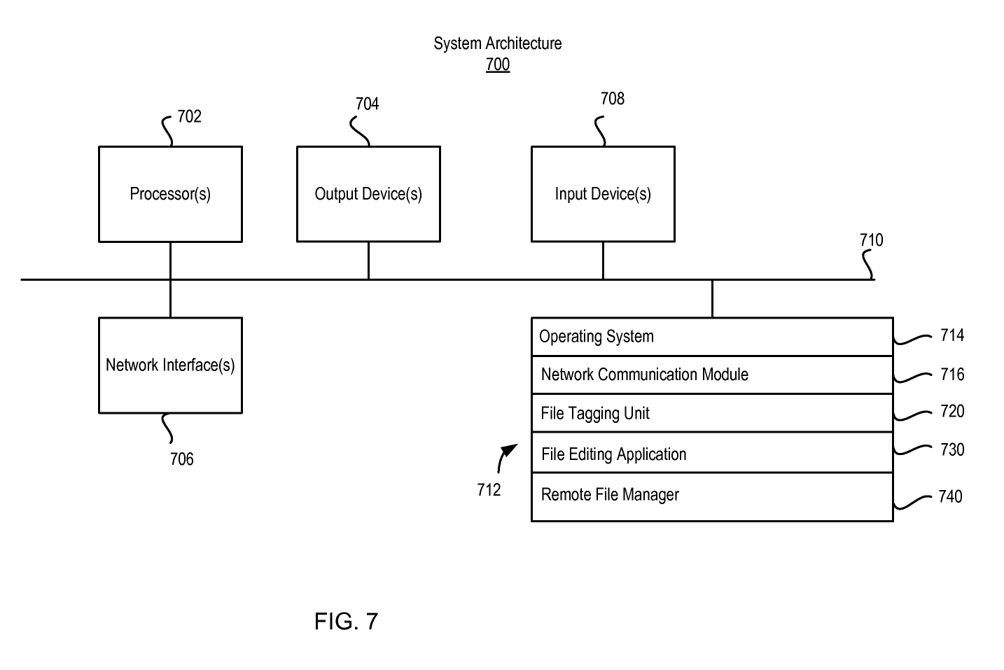

FIG. 7 is a block diagram of exemplary system architecture 700 for implementing the features and operations of FIGS. 1-6. Other architectures are possible, including architectures with more or fewer components. In some implementations, architecture 700 includes one or more processors 702 (e.g., dual-core Intel® Xeon® Processors), one or more output devices 704 (e.g., LCD), one or more network interfaces 706, one or more input devices 708 (e.g., mouse, keyboard, touch-sensitive display) and one or more computer-readable mediums 712 (e.g., RAM, ROM, SDRAM, hard disk, optical disk, flash memory, etc.). These components can exchange communications and data over one or more communication channels 710 (e.g., buses), which can utilize various hardware and software for facilitating the transfer of data and control signals between components.

The term “computer-readable medium” refers to any medium that participates in providing instructions to processor 702 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 712 can further include operating system 714 (e.g., Mac OS® server, Windows Server®, or iOS®), network communication module 716, file tagging unit 720, file editing application 730, and remote file manager 740. Operating system 714 can be multi-user, multiprocessing, multitasking, multithreading, real time, etc. Operating system 714 performs basic tasks, including but not limited to: recognizing input from and providing output to devices 706, 708; keeping track and managing files and directories on computer-readable mediums 712 (e.g., memory or a storage device); controlling peripheral devices; and managing traffic on the one or more communication channels 710. Network communications module 716 includes various components for establishing and maintaining network connections (e.g., software for implementing communication protocols, such as TCP/IP, HTTP, etc.). File tagging unit 720 can include instructions that, when executed, causes processor 702 to perform operations of file history subsystem 302 as described above in reference to FIG. 3. The operations can include procedure 600 as described in reference to FIG. 6. File editing application 730 can be an application for editing or otherwise modifying an electronic document. File editing application 730 can request tag detector 312 to detect if the electronic document contains a file tag, and if the electronic document contains a file tag, configured to present user interface 502 or 510 as provided by file tagging unit 720 for display. Remote file manager 740 can be configured to open a copy of the electronic document remotely.

Architecture 700 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations of the invention have been described. Nevertheless, it will be understood that various modifications can be made without departing from the spirit and scope of the invention.

What is claimed is:

1. A method comprising:
receiving, by a computing device, a first request to generate a copy of an electronic document stored on a first storage device and store the copy on a second storage device, the request including a path on the second storage device for storing the copy;
determining, by the computing device, a file tag, the file tag comprising an identifier of the second storage device, a representation of the path, and a representation of an identifier of the copy;
modifying, by the computing device, the electronic document, including storing the file tag as a component of the electronic document;
receiving, by the computing device, a second request to edit the electronic document stored on the first storage device; and
presenting, based on the file tag and as a response to the second request, a first option of selecting the electronic document stored on the first storage device for editing and a second option of selecting the copy stored on the second storage device for editing.

2. The method of claim 1, wherein:
the first storage device is a storage device that is local to the computing device; and
the second storage device is a storage device located remote to the computing device and connected to the computing device through a communications network.

3. The method of claim 2, wherein:
the second storage device is a cloud storage device;
the identifier of the second storage device comprises a service identifier identifying a cloud storage service that manages the cloud storage device; and
the path comprises a tenant identifier identifying an exclusive virtual computing environment of the cloud storage service for storing the copy.

4. The method of claim 2, wherein:
the second storage device is a network-attached storage (NAS) device; and
the identifier of the second storage device comprises an identifier of the network and a network address of the NAS device in the network.

5. The method of claim 2, wherein:
the second storage device is a content repository and management system, the content repository and management system including a database server.

6. The method of claim 1, wherein the file tag is stored in metadata of the electronic document as a value of a reserved key, the metadata being associated with the electronic document wherein, when the electronic document is copied by an operating system of the computing device, the metadata is copied with the electronic document.

7. The method of claim 1, comprising:
determining, by the computing device, that the electronic document is open when the first request was received;
closing the electronic document before generating the copy; and
determining the file tag after storing the copy on the second storage device.

8. The method of claim 1, comprising, after presenting the options:
in response to an input selecting a first option, opening the electronic document for editing; or
in response to an input selecting a second option, opening the copy for editing.

9. The method of claim 8, comprising: in response to the input selecting the first option, presenting a user interface item for receiving an input for removing the file tag from the electronic document.

10. The method of claim 1, wherein:
the electronic document is associated with a plurality of file tags, each of the file tags identifying a unique remote storage device or a unique path, and
upon receiving the second request, presenting an option corresponding to each unique remote storage device or unique path.

11. A system comprising:
a computing device; and
a non-transitory storage medium coupled to the computing device and storing instructions operable to cause the computing device to perform operations comprising:
receiving a first request to generate a copy of an electronic document stored on a first storage device and store the copy on a second storage device, the request including a path on the second storage device for storing the copy;
determining a file tag, the file tag comprising an identifier of the second storage device, a representation of the path, and a representation of an identifier of the copy;
modifying the electronic document, including storing the file tag as a component of the electronic document;
receiving a second request to edit the electronic document stored on the first storage device; and
presenting, based on the file tag and as a response to the second request, a first option of selecting the electronic document stored on the first storage device for editing and a second option of selecting the copy stored on the second storage device for editing.

12. The system of claim 11, wherein:
the first storage device is a storage device that is local to the computing device; and
the second storage device is a storage device located remote to the computing device and connected to the computing device through a communications network.

13. The system of claim 12, wherein:
the second storage device is a cloud storage device;
the identifier of the second storage device comprises a service identifier identifying a cloud storage service that manages the cloud storage device; and
the path comprises a tenant identifier identifying an exclusive virtual computing environment of the cloud storage service for storing the copy.

14. The system of claim 12, wherein:
the second storage device is a network-attached storage (NAS) device; and
the identifier of the second storage device comprises an identifier of the network and a network address of the NAS device in the network.

15. The system of claim 11, wherein the file tag is stored in metadata of the electronic document as a value of a reserved key, the metadata being associated with the electronic document wherein, when the electronic document is copied by an operating system of the computing device, the metadata is copied with the electronic document.

16. The system of claim 11, the operations comprising:
determining that the electronic document is open when the first request was received;
closing the electronic document before generating the copy; and
determining the file tag after storing the copy on the second storage device.

17. The system of claim 11, the operations comprising, after presenting the options:
in response to an input selecting a first option, opening the electronic document for editing; or
in response to an input selecting a second option, opening the copy for editing.

18. The system of claim 11, wherein:
the electronic document is associated with a plurality of file tags, each of the file tags identifying a unique remote storage device or a unique path, and
upon receiving the second request, presenting an option corresponding to each unique remote storage device or unique path.

19. A non-transitory storage medium coupled to a computing device and storing instructions operable to cause the computing device to perform operations comprising:
receiving a first request to generate a copy of an electronic document stored on a first storage device and store the copy on a second storage device, the request including a path on the second storage device for storing the copy;
determining a file tag, the file tag comprising an identifier of the second storage device, a representation of the path, and a representation of an identifier of the copy;
modifying the electronic document, including storing the file tag as a component of the electronic document;
receiving a second request to edit the electronic document stored on the first storage device; and
presenting, based on the file tag and as a response to the second request, a first option of selecting the electronic document stored on the first storage device for editing and a second option of selecting the copy stored on the second storage device for editing.

20. The non-transitory storage medium of claim 19, wherein:
the first storage device is a storage device that is local to the computing device; and
the second storage device is a storage device located remote to the computing device and connected to the computing device through a communications network.

21. The non-transitory storage medium of claim 20, wherein:
the second storage device is a cloud storage device;
the identifier of the second storage device comprises a service identifier identifying a cloud storage service that manages the cloud storage device; and
the path comprises a tenant identifier identifying an exclusive virtual computing environment of the cloud storage service for storing the copy.

22. The non-transitory storage medium of claim 20, wherein:
the second storage device is a network-attached storage (NAS) device; and
the identifier of the second storage device comprises an identifier of the network and a network address of the NAS device in the network.

23. The non-transitory storage medium of claim 19, wherein the file tag is stored in metadata of the electronic document as a value of a reserved key, the metadata being associated with the electronic document wherein, when the electronic document is copied by an operating system of the computing device, the metadata is copied with the electronic document.

24. The non-transitory storage medium of claim 19, the operations comprising:
determining that the electronic document is open when the first request was received;
closing the electronic document before generating the copy; and
determining the file tag after storing the copy on the second storage device.

25. The non-transitory storage medium of claim 19, the operations comprising, after presenting the options:
in response to an input selecting a first option, opening the electronic document for editing; or
in response to an input selecting a second option, opening the copy for editing.

26. The non-transitory storage medium of claim 19, wherein:
the electronic document is associated with a plurality of file tags, each of the file tags identifying a unique remote storage device or a unique path, and upon receiving the second request, presenting an option corresponding to each unique remote storage device or unique path.
